(19) United States
(12) Patent Application Publication
(10) Pub. No.: US 2006/0290582 A1
(43) Pub. Date: Dec. 28, 2006

(54) TUNABLE ANTENNA CONTROL UNIT

(75) Inventor: YONG BUM LEE, KYUNGKI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/426,894

(22) Filed: Jun. 27, 2006

(30) Foreign Application Priority Data
Jun. 28, 2005 (KR) 10-2005-0056158

(51) Int. Cl. H01Q 9/00

(52) U.S. Cl. 343/745

(57) ABSTRACT

The invention relates to a tunable antenna installed inside a mobile communication terminal to process multiple bands according to selection of reception frequency of a signal, and a control unit therefor. The tunable antenna includes an antenna for processing at least two different RF signals and an RF processor for receiving the RF signal from the antenna through a data signal line to convert the signal to a baseband signal. The tunable antenna further includes an antenna controller for providing a direct-current control signal for converting a band processed by the antenna through the data signal line, and an antenna tuner for receiving the direct-current control signal to convert the band processed by the antenna.

### CLAIM OF PRIORITY

This application claims the benefit of Korean Patent Application No. 2005-56158 filed on Jun. 28, 2005, in the Korean Intellectual Property Office, the disclosure of which is incorporated herein by reference.

### BACKGROUND OF THE INVENTION

1. Field of the Invention

The present invention relates to an antenna of a mobile communication terminal, and more particularly, to a tunable antenna unit installed in a mobile communication terminal to process multiple bands according to selection of a frequency of a reception signal, and a control unit therefor.

2. Description of the Related Art

Recently, advancement in mobile technologies for a mobile communication terminal has led to diversity in frequency bands used by the antenna of the mobile communication terminal.

Specifically, the frequency bands used by the mobile communication terminal include 800 MHz-2 GHz (mobile phone), 2.4 GHz, 5 GHz (wireless LAN), 113.56 MHz (non-contact RFID), 2.4 GHz (Bluetooth), 1.575 GHz (GPS), 76-90 MHz (FM radio), 470-770 MHz (Television broadcasting), UWB, Zigbee and Digital Multimedia Broadcasting (DMB) and Digital Video Broadcasting (DVB-H). The DMB is divided into a satellite DMB using ultra high frequency (UHF) (2535-2655 MHz) and a terrestrial DMB using very high frequency (VHF) (174-216 MHz).

Also, the DVB-H is categorized into an UHF DVB-H using UHF and a satellite DVB-H using L-Band frequencies.

The mobile communication terminal needs to be miniaturized and light-weighted while at the same time, capable of providing various services.

In order to meet such needs, the antenna and other components adopted in the mobile communication terminal are becoming more multi-functional and miniaturized. These days, the antenna for the mobile telecommunication terminal is installed inside the terminal. Thus, the antenna for the mobile communication terminal is required to occupy little space inside the terminal while performing with satisfactory capabilities.

As discussed above, various types of tunable antennas are used for receiving different bands of communication or broadcast signals through the mobile communication terminal. And by supplying a particular control signal to such a tunable antenna, the reception frequency band can be converted to allow the mobile communication terminal to provide various services.

FIG. 1 is a block diagram illustrating a control unit for converting a band of a conventional antenna.

Referring to FIG. 1, the conventional tunable antenna control unit includes a tunable antenna unit 10 for receiving different bands of RF signals and a receiver 13 for recovering the RF signal received through the tunable antenna unit 10.

The tunable antenna unit 10 includes an antenna 11 and an antenna tuning circuit 12. The antenna 11 is capable of adjusting impedance to receive different bands of signals. The antenna tuning circuit 12 provides an antenna control signal for selecting a frequency band processed by the antenna 11.

The receiver 13 includes an RF processor 14 and an antenna controller 15. The RF processor 14 receives an RF data signal from the antenna 11 through a data signal line 16, and converts the RF signal into a baseband signal. The antenna controller 15 provides a control signal for selecting the band processed by the antenna 11 to the antenna tuning circuit 12 through a control signal line 17. Thereby, the band of the signal processed by the antenna 11 can be converted in order for the mobile communication to provide various communication services.

As described above, the conventional tunable antenna control unit is provided with the data signal line 16 for receiving a data signal as well as the control signal line 17 for supplying a control signal for converting the frequency band at which the antenna 11 receives a signal, connecting between the tunable antenna unit 10 including the antenna 11 and the receiver 13. However, separate configuration of the data signal line 16 and the control signal line 17 complicates the circuit, and as the control signal line 17 occupies a separate area inside the terminal, miniaturization of the mobile communication terminal is difficult. Furthermore, since the control signal line 17 is separately formed adjacent to the antenna 11, the control signal transmitted through the control signal line 17 may affect the capabilities of the antenna 11, distorting the reception signal.

### SUMMARY OF THE INVENTION

The present invention has been made to solve the foregoing problems of the prior art and therefore an object of certain embodiments of the present invention is to provide a tunable antenna unit installed in a small size inside a mobile communication terminal to receive and process various frequency bands of signals.

Another object of certain embodiments of the invention is to provide a tunable antenna control unit capable of controlling the tunable antenna unit through a data signal line without using a separate control signal line, thereby preventing the effects of an outside circuit or current that may distort a data signal.

According to an aspect of the invention for realizing the object, there is provided a tunable antenna control unit including: an antenna for processing at least two different radio frequency (RF) signals; an RF processor for receiving each of the RF signals from the antenna through a data signal line to convert the RF signal to a baseband signal; an antenna controller for providing a direct-current control signal through the data signal line to convert a band processed by the antenna; and an antenna tuner for receiving the direct-current control signal to convert the band processed by the antenna.

According to another aspect of the invention for realizing the object, there is provided a tunable antenna unit including: an antenna having a plurality of radiators for processing at least two different RF signals and providing RF signals received from the plurality of radiators through a data signal line to an RF processor; and an antenna tuner for receiving a direct current control signal to convert a band processed by the antenna through the data signal line, thereby converting the band processed by the antenna.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional tunable antenna control unit;

FIG. 2 is a block diagram illustrating a tunable antenna control unit according to a certain embodiment of the present invention;

FIG. 3 is a block diagram illustrating a tunable antenna unit according to a certain embodiment of the present invention: and

FIG. 4 is a block diagram illustrating a tunable antenna unit according to another embodiment of the present invention.

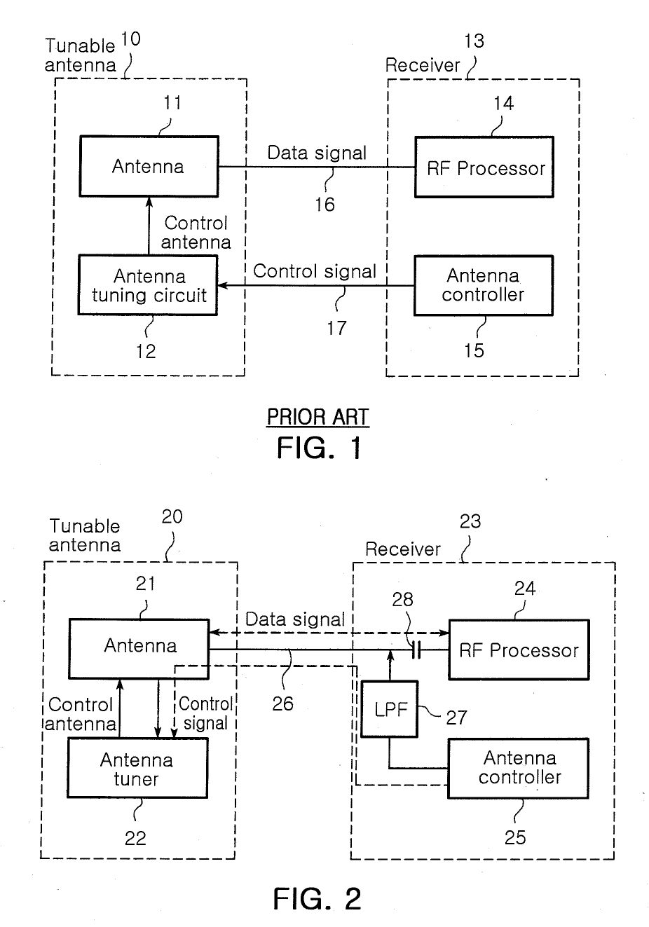

### DETAILED DESCRIPTION OF THE PREFERRED EMBODIMENT

Preferred embodiments of the present invention will now be described in detail with reference to the accompanying drawings.

The same reference numerals are used throughout to designate the same or similar components. In the following description, well-known functions and constructions are not described in detail since they would obscure the intention in unnecessary detail.

FIG. 2 is a block diagram illustrating a tunable antenna control unit according to a certain embodiment of the present invention.

Referring to FIG. 2, the tunable antenna control unit according to a certain embodiment of the invention includes a tunable antenna unit 20 mounted in a mobile communication terminal, capable of receiving a plurality of bands of signals, and a receiver 23 for recovering a signal received at the tunable antenna unit 20.

The tunable antenna unit 20 includes an antenna 21 and an antenna tuner 22. The antenna 21 is capable of adjusting impedance to receive multiple bands of signals. The antenna tuner 22 provides an antenna control signal for selecting a frequency band processed by the antenna 21.

The receiver 23 includes an RF processor 24, an antenna controller 25, a Low Pass Filter (LPF) 27 and a High Pass Filter (HPF) 28.

The RF processor 24 is connected to the antenna 21 through a data signal line 26, and receives an RF data signal through the data signal line 26 from the antenna 21. The RF signal received by the RF processor 24 is converted to a baseband signal which is provided to a baseband processor (not shown) where the data is interpreted.

The antenna controller 25 provides a direct-current control signal for converting a band processed by the antenna 21 through the data signal line 26.

The LPF 27 has an end connected to the data signal line 26 and the other end connected to the antenna controller 25. The LPF 27 passes the direct-current control signal provided by the antenna controller 25 while blocking the RF signal running on the data signal line 26 from entering the antenna controller 25.

The HPF 28 connects between the antenna 21 and the RF processor 24 and functions to block the direct-current control signal provided by the antenna controller 25 from entering the RF processor 24. A capacitor can be adopted for the HPF 28 to prevent the direct-current control signal from entering the RF processor 24, as shown in FIG. 2.

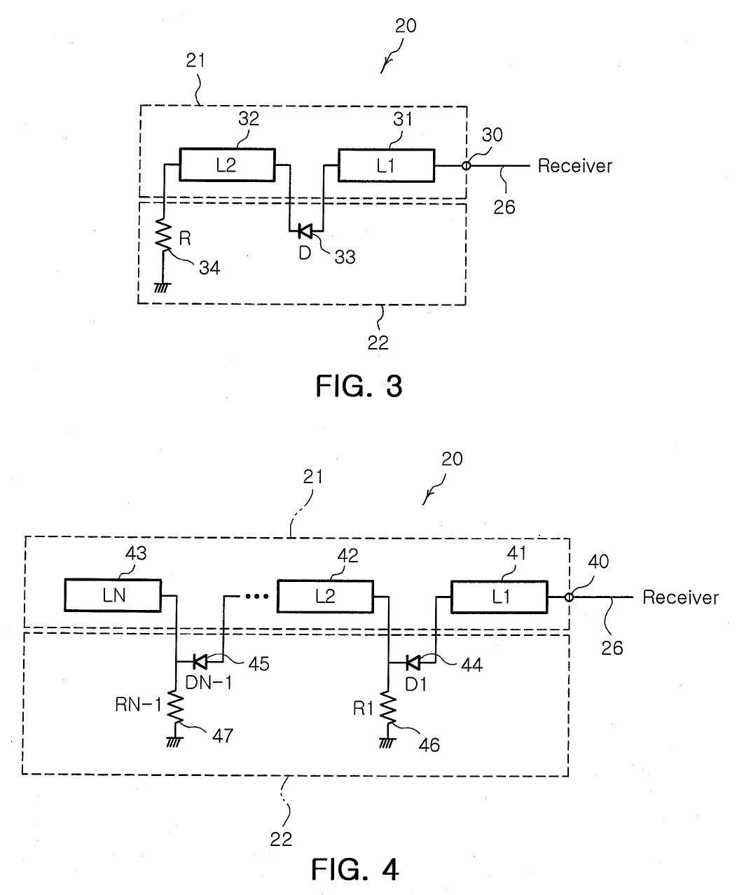

FIG. 3 is a configuration view illustrating a tunable antenna unit according to a certain embodiment of the present invention.

Referring to FIG. 3, the tunable antenna unit according to a certain embodiment of the invention includes an antenna 21 having a plurality of radiators L1 and L2 (31 and 32) and an antenna tuner 22 for converting a band processed by the antenna 21.

The antenna 21 includes a first radiator L1 for processing an RF signal of a first band, and a second radiator L2 for processing an RF signal of a second band together with the first radiator L1. The antenna 21 provides the RF signal received through the first and second radiators L1 and L2 to an RF processor 24 of a receiver 23 through a data signal line 26.

The first radiator L1, if used singly, can be formed in an electric resonance length for transmitting and receiving, for example, high frequency band of 750 MHz among the ultra high frequency (UHF) band (470 to 7500 MHz). The second radiator L2, if used in connection with the first radiator L1, the sum length of the first radiator L1 and the second radiator L2 can equal an electric resonance length for transmitting and receiving, for example, a low frequency band of 470 MHz among the ultra high frequency (UHF) band (470 to 7500 MHz). The first and second radiators L1 and L2 can be formed in various types such as a helical type, meander type, plate type and strip line.

The antenna tuner 22 includes a diode D (33) and a bias resistor R (34) and functions to electrically connect or disconnect between the first and second radiators L1 and L2, thereby adjusting impedance of the antenna 20, which allows the antenna 20 to use only the first radiator L1 or both the first and second radiators L1 and L2 connected to each other.

The diode D has an anode connected to an end of the first radiator L1 and a cathode connected to an end of the second radiator L2. The diode D is electrically turned off if supplied with a direct-current control signal of, for example, less than 0.7 volts from the antenna controller 25. At this time, the antenna 20 uses only the first radiator L1, 31 to process an RF signal of a first band. On the other hand, the diode D, 33 is electrically turned on if supplied with a direct-current control signal of, for example, above 0.7 volts from the antenna controller 25. At this time, the antenna 21 uses both the first and second radiators L1 and L2 connected to each other to process an RF signal of a second band.

The bias resistor R has an end connected to a cathode path of the diode D and the other end grounded to provide bias to the diode D. Therefore, as shown in FIG. 3, the bias resistor R can have an end connected to the other end of the second radiator L2 and the other end grounded. In addition, the bias resistor R needs to form a direct-current connection, and thus can have an end connected to a contact point of an end of the second radiator L2 and a cathode of the diode D, and the other end grounded.

FIG. 4 is a configuration view illustrating a tunable antenna unit according to another certain embodiment of the present invention.

Referring to FIG. 4, the tunable antenna unit according to another embodiment of the invention includes an antenna 21 having a plurality of radiators L1, L2, . . . , LN (41, 42, . . . , 43) and an antenna tuner 22 for converting a band processed by the antenna 21.

As seen in comparison with the structure in FIG. 3, the antenna 21 has a plurality of radiators L1, L2, . . . , LN connected in cascade. The plurality of radiators L1, L2, . . . , LN are connected in series with one another to process different bands of signals in various combinations with one another, using the direct-current control signal received through the data signal line 26, at a feeding terminal 40 formed at an end of the antenna 21.

The antenna tuner 22 includes a plurality of diodes D1, . . . , DN-1 (44, . . . , 45) and a plurality of bias resistors R1, . . . , RN-1 (46, . . . , 47). The plurality of diodes D1, . . . , DN-1 are connected between the plurality of radiators L1, L2, . . . , LN. That is, the first diode D1 has an anode connected to the first radiator L1 and a cathode connected to a second radiator L2. The (N-1)^{th} diode DN-1 has an anode connected to the (N-1)^{th} radiator LN-1 (not shown) and a cathode connected to the N^{th} radiator LN. The plurality of diodes D1, . . . , DN-1 are electrically turned on or off using the direct-current control signal provided through the data signal line 26, thereby adjusting the electric resonance length of the antenna 21. For example, when the first diode D1 is turned off by the direct-current control signal, the antenna 20 uses only the first radiator L1 to process an RF signal of a first band. On the other hand, when the plurality of diodes D1, . . . , DN-1 are all electrically turned on by the direct-current control signal, the antenna 21 uses the plurality of radiators L1, L2, . . . , LN all connected to one another to process an RF signal of another N^{th} band. That is, the plurality of diodes D1, . . . , DN-1 are selectively turned on or off by the direct-current control signal provided through the data signal line 26 to process various bands.

Each of the plurality of bias resistors R1, . . . , RN-1 has an end connected to a cathode path of a corresponding one of the plurality of diodes D1, . . . , DN-1, and the other end grounded to provide bias to the plurality of diodes D1, . . . , DN-1.

According to certain embodiments of the present invention set forth above, a tunable antenna unit can be manufactured in a simple, small-sized structure, and can advantageously receive and process various bands of signals.

In addition, a tunable antenna control unit can control the tunable antenna unit to convert a band processed by the tunable antenna unit using already established data signal line without forming an additional control signal line, thereby advantageously preventing distortion of a data signal by an outside circuit or current.

While the present invention has been shown and described in connection with the preferred embodiments, it will be apparent to those skilled in the art that modifications and variations can be made without departing from the spirit and scope of the invention as defined by the appended claims.

What is claimed is:

1. A tunable antenna control unit comprising:
an antenna for processing at least two different radio frequency (RF) signals;
an RF processor for receiving each of the RF signals from the antenna through a data signal line to convert the RF signal to a baseband signal;
an antenna controller for providing a direct-current control signal through the data signal line to convert a band processed by the antenna; and
an antenna tuner for receiving the direct-current control signal to convert the band processed by the antenna.

2. The tunable antenna control unit according to claim 1, wherein the antenna comprises:
a first radiator for processing an RF signal of a first band, and
a second radiator connected to the first radiator to process an RF signal of a second band together with the first radiator.

3. The tunable antenna control unit according to claim 2, wherein the antenna tuner comprises:
a diode having an anode connected to an end of the first radiator and a cathode connected to an end of the second radiator, the diode being electrically opened or closed by the direct-current control signal; and
a bias resistor having an end connected to the second radiator and the other end grounded to provide bias to the diode.

4. The tunable antenna control unit according to claim 1, wherein the antenna comprises a plurality of radiators connected in series with one another, the radiators forming different impedances in various combinations with one another to process different bands of RF signals.

5. The tunable antenna control unit according to claim 4, wherein the antenna tuner comprises:
a plurality of diodes connected to the plurality of radiators, the diodes being electrically opened or closed by the direct-current control signal; and
a plurality of bias resistors each having an end connected to a cathode of a corresponding one of the diodes and the other end grounded, each bias resistor providing bias to the corresponding one of the diodes.

6. The tunable antenna control unit according to claim 1, further comprising:
a low pass filter having one end connected to the data signal line and the other end connected to the antenna controller to pass the direct-current control signal while blocking the RF signal from entering the antenna controller.

7. The tunable antenna control unit according to claim 1, further comprising a capacitor connecting between the antenna and the RF processor to block the direct-current control signal from entering the RF processor.

8. A tunable antenna unit comprising:
an antenna having a plurality of radiators for processing at least two different RF signals and providing RF signals received from the plurality of radiators through a data signal line to an RF processor; and
an antenna tuner for receiving a direct current control signal to convert a band processed by the antenna through the data signal line, thereby converting the band processed by the antenna.

9. The tunable antenna according to claim 8, wherein the antenna comprises:
a first radiator for processing an RF signal of a first band; and
a second radiator connected to the first radiator to process an RF signal of a second band together with the first radiator.

10. The tunable antenna according to claim 9, wherein the antenna tuner comprises:
a diode having an anode connected to an end of the first radiator and a cathode connected to an end of the second radiator, the diode being electrically opened or closed by the direct-current control signal; and
a bias resistor having an end connected to an end of the second radiator and the other end grounded to provide bias to the diode.

11. The tunable antenna according to claim 8, wherein the antenna comprises a plurality of radiators connected in series with one another to form different impedances in various combinations with one another, thereby processing different bands of RF signals.

12. The tunable antenna according to claim 11, the antenna tuner comprises:
a plurality of diodes connecting between the plurality of radiators, the diodes being electrically opened or closed by the direct-current control signal; and
a plurality of bias resistors each having an end connected to one of the radiators and the other end grounded to provide bias to the plurality of diodes.
